(19) United States
(12) Patent Application Publication
(10) Pub. No.: US 2006/0149727 A1
(43) Pub. Date: Jul. 6, 2006

(54) Content control

(75) Inventor: Minna Viitaharju, Helsinki (FI)

Correspondence Address: WARE FRESSOLA VAN DER SLUYS &;ADOLPHSON, LLP, BRADFORD GREEN, BUILDING 5, 755 MAIN STREET, P O BOX 224, MONROE, CT, 06468, US

(73) Assignee: Nokia Corporation

(21) Appl. No.: 11/316,365

(22) Filed: Dec. 21, 2005

(30) Foreign Application Priority Data
Dec. 23, 2004 (WO) PCT/IB04/04254

(51) Int. Cl. G06F 17/30

(52) U.S. Cl. 707/5

(57) ABSTRACT

The invention relates to content which can be accessed via a user device 20. In order to allow preventing users of a user device in an efficient and flexible way from consuming content to which they should not have access, a second device 26 stores an indication 29 of at least one attribute associated to a user, which is accessible by the user device 20. When an access to content is requested, the user device compares the available rating information with the available attribute indication, the user device 11 determines whether a user is allowed to access the requested content, and allows or prevents an access to the content accordingly.

### FIELD OF THE INVENTION

The invention relates to a processing module for a user device. The invention relates equally to a corresponding user device, and to a method, a software code and a software program product for such a user device. The invention relates further to a processing module for a network element of a communication network, which communication network enables a user device to download content. The invention relates equally to a corresponding network element, and to a method, a software code and a software program product for such a network element.

### BACKGROUND OF THE INVENTION

Many user devices enable a user to download content from a server of a content provider via a communication network. Such content may comprise for instance pictures, videos, games, etc.

In some situations, however, it might be desirable to restrict the consumption of certain content at the side of the user of a user device.

Many parents, for example, do not wish that their minor children consume certain types of content which can be downloaded for “adult” entertainment. Further, they might wish to prevent use of content that opens a connection to some site, which is chargeable either by visit or depending on the time of the connection.

Further, some corporations may wish to prevent their employees from downloading and consuming dangerous, harmful, expensive or otherwise vain content via corporate user devices.

It is known to completely prevent the access to downloadable content, for example by preventing that a mobile terminal calls certain mobile numbers of service providers, which raise a charge for the call.

This approach has the disadvantage, though, that beside inappropriate content, harmless or useful content is denied as well to the mobile user.

For example, some parents would be willing to enable their children to make use of entertainment content, if they could be sure that only content which is appropriate for children can be consumed.

Similarly, enterprises would usually want to allow at least a download and consumption of useful content via corporate user devices.

In U.S. Pat. No. 6,052,070, a safety profile for a mobile device is described. When using this safety profile, however, entire applications are blocked.

In US patent application 2004/0107356 A1, it has been proposed to provide encrypted content to a mobile terminal. Decrypting means decrypt the content under control of control means in accordance with rules received as part of the content. This means, however, that the content is downloaded in any case to the mobile terminal and has thus to be paid for if the download involves a charge. Further, the rules do not take account of the type of content.

In U.S. Pat. No. 6,112,181, it has been proposed to manage a huge amount of available information by a matching and classification utility system on the side of a server providing the information, based for instance on a class membership.

In U.S. Pat. No. 6,185,683, a secure and trusted delivery of digital information from a sender to a particular receiver via an electronic network is dealt with. Secure control means can specify how an item is to be processed, but the rules depend on the requirements of the sender.

### SUMMARY OF THE INVENTION

It is an object of the invention to allow preventing users of a user device in an efficient way from consuming content to which they should not have access.

For a user side, a processing module for a user device is proposed. The processing module is adapted to compare at least one attribute associated to a user of the user device, an indication of which at least one attribute is stored in a second device and is accessible by the user device, with information on a rating of content, when content is requested to be accessed and when information on a rating of the content is available in the user device. The processing module is further adapted to determine based on the comparison whether the content is allowed to be accessed by the user.

For a user side, moreover a user device is proposed, which comprises communication means for communicating with a communication network and the processing module proposed for the user side.

For the user side, moreover a user system is proposed, which comprises such a user device and a second device storing the indication of the attribute.

For a user side, moreover a method for controlling in a user device an access to content is proposed. The proposed method comprises comparing at least one attribute associate to a user of the user device, an indication of which at least one attribute is stored in a second device and is accessible by the user device, with information on a rating of content, when content is requested to be accessed and when information on a rating of the content is provided via the communication network to the user device. The proposed method further comprises determining based on the comparison whether the content is allowed to be accessed by the user.

For a user side, moreover a software code for controlling in a user device an access to content is proposed. The software code realizes the steps of the method proposed for the user side when running in a processing module of a user device.

For a user side, finally a software program product is proposed which stores such a software code proposed for the user side.

For a content provider side, a processing module for a network element of a communication network is proposed.

It is assumed that the communication network enables a user device to download content. The processing module is adapted to provide for content requested by a user device information on a content dependent rating. The rating indicates whether a user is to be allowed by a user device to access the content, depending on at least one attribute associated to a user, an indication of which at least one attribute is stored in a second device accessible by a respective user device.

For a content provider side, moreover a method is proposed for supporting in a network element of a communication network a control by a user device of an access to content. The method comprises providing for content requested by a user device information on a content dependent rating, which rating indicates whether a user is to be allowed by a user device to access the content, depending on at least one attribute associated to a user, an indication of which at least one attribute is stored in a second device accessible by a respective user device.

For a content provider side, moreover a network element is proposed, which comprises the processing module proposed for the content provider side.

For a content provider side, moreover a software code for controlling at a network element of a communication network a control by a user device of an access to content is proposed. The software code realizes the steps of the method proposed for the content provider side when running in a processing module of a network element.

For a content provider side, finally a software program product is proposed, which stores the software code proposed for the content provider side.

Finally, a communication system is proposed, which comprises the proposed user device and the proposed network element.

The invention proceeds from the consideration that often, it is only desired to prevent persons from consuming certain types of content, not from consuming any content in general. It is therefore proposed to implement user-specific business rules. More specifically, a second device stores information on at least one attribute associated to a user. When an application of the user device requests consumption of content or a download of content from the network element, the user device may then first evaluate based on an available rating information for this content whether a user, to which the available at least one attribute is associated, is allowed to consume content with the received rating, and allow or prevent an access to the content, in particular a use or a download, accordingly.

It is an advantage of the invention that it allows controlling or filtering a use and/or a download of content at a user end based on a rating of the content on the network side. This allows preventing persons from consuming content to which they should not have access. At the same time, the rating ensures that a total blocking is not required, which makes the invention particularly flexible. Users may thus make use of appropriate types of content nevertheless, and content providers are able to provide content to these users, as long as the content is rated to be suitable.

By preventing already the download of content, it is ensured that a possible charge has not to be paid for content, which is not to be consumed anyhow.

If a download of content from a communication network is to be controlled, the network may provide the rating information for a requested content to the user device.

In addition to a download control, however, there may be a desire to control as well the actual consumption of content, which is already available in the user device. This may be content, for example, which is pushed or pulled into the device from a personal computer (PC) or from another device. The connection for such a push or pull transmission may be a wired connection or a wireless connection, for example a Bluetooth™ connection, an Infrared Data Association (IrDA) connection, a wireless local area network (WLAN) connection, etc. Equally, it may be content, which is made available to the user device via an exchangeable memory, like a memory card. In these cases, the rating information may be provided together with the content.

Moreover, content which has been determined not to be allowed to be accessed by a user may be modified, for instance by a file management system forming part of the proposed processing module. Such content may be made invisible to the user, for example by marking it with a “hide” attribute. Alternatively or in addition, such content may be made unusable to a user, for instance by claiming that the content is corrupted. Alternatively or in addition, such content may be made impossible to forward or to copy, for instance by forward-locking it. These measures allow preventing that an available content which is considered unsuitable for a user is simply copied to another user device which is not provided with a content access control or with a limited content access control.

Some content may be protected by a digital rights management (DRM). Such DRM protected content may be offered for instance by operators or content providers for a charge and allows only a particular device or group of devices to consume the content by means of an encryption. In these cases, the content provider might transmit DRM related information beforehand to a user device requesting content anyhow, for instance for indicating the charge for the content.

In one embodiment of the invention, the rating information is included in DRM related information provided to the user device, for example in form of a rating label. In another embodiment of the invention, the rating information is retrieved from a secure server whenever a use or a download is requested with a user device comprising a predetermined attribute associated to a user. Such a secure server can be, for example, a server maintained by the operator of a mobile communication network or a server maintained by a corporate security department. The proposed network element may be realized as such a secure server.

The invention can be employed in particular, though not exclusively, for an age related content control. An age related content control allows parents, for example, to ensure that only suitable content is available to their minor children.

If the content control is age related, the rating information is related to an age of users which are to be allowed to consume the content. Correspondingly, the attribute associated to a user of the user device is related in this case to an age of the user.

Alternatively, the invention can be employed, for example, for a corporation specific content control. Such a control enables a corporation for example to restrict the access to downloadable content, like applications, links, etc., which could cause dangerous or insecure actions, or actions which could be expensive to the corporation. Content from accepted sites, in contrast, may be downloaded and consumed. In this case, rating information and attribute may be related to a “corporate user” identification (ID).

The rating information provided by the network element can be of various kinds. For example, a single rating label may be defined, which can be present or not, or a plurality of rating labels may be defined. A present single rating label may indicate for example that the requested content is not suited for minors. Otherwise, the content can be considered to be appropriate for minors. Alternatively, a present single rating label may indicate in contrast that content is suitable for minors. Otherwise, the content might not be appropriate for minors. Further alternatively, the rating may indicate an age until which a consumption of the requested content should be prevented. In the latter case, various ages can be indicated depending on the type of the content.

Rating information provided by a secure server can be based, for example, on a list or another categorization of acceptable content from trusted sources. Upon inquiry about a specific content, the secure server may then provide a respective rating, for instance a particular age or a particular “corporate user” ID for which the requested content is “acceptable content from trusted sources”.

Also the indicated attribute can be of various kinds.

In case of an age related control, it can be for example simply an indication that the user is minor. Further, it may indicate the age of the user or the date of birth of the user. In the first case, it might be desired to update the age occasionally. In the second case, the respectively correct age can be determined automatically, but it has to be ensured that the date information used by the device for determining the correct age from the indicated date of birth cannot be tampered with by the user.

In case of a corporation related control, the indicated attribute can be for example a “corporate user” ID. In case the user device is a mobile terminal, the indication of the attribute may be stored for example in a subscriber identity module (SIM). Alternatively, however, the indication of the attribute may be stored in any other second device. The indication may be retrieved by the user device from the second device and used directly for a content control. Alternatively, it may be used to update a user profile whenever a download of content is requested.

The indication of the attribute may not be changeable by a user. In case the device is a mobile terminal, the indication may be stored to this end for example by a network operator in a secure space of a SIM. Alternatively, the indication of the attribute can be changeable. Also in this case, the indication is advantageously stored in a tamper resistant storage space of the second device, which can only be accessed, for example, by entering a predetermined code. It is an advantage of a SIM that it already has security mechanisms of its own, which make it possible to hide information, like age, date of birth or a corporate ID, under a lock code in a secure space.

The user device can be any device which enables a user to consume content and/or to download content via a communication network. It can be for instance a mobile terminal, which allows downloading content via a mobile communication network. It can also be for instance a personal computer (PC) which allows downloading content via the Internet. The second device may also store indications of attributes which are associated to a plurality of users. The users may then be differentiated, for example, by a password which has to be entered when activating the user device.

### BRIEF DESCRIPTION OF THE FIGURES

Other objects and features of the present invention will become apparent from the following detailed description considered in conjunction with the accompanying drawings.

FIG. 1 is a schematic block diagram of a communication system station according to an embodiment of the invention;

FIG. 2 is a flow chart illustrating a first operation in the system of FIG. 1; and

FIG. 3 is a flow chart illustrating a second operation in the system of FIG. 1.

### DETAILED DESCRIPTION OF THE INVENTION

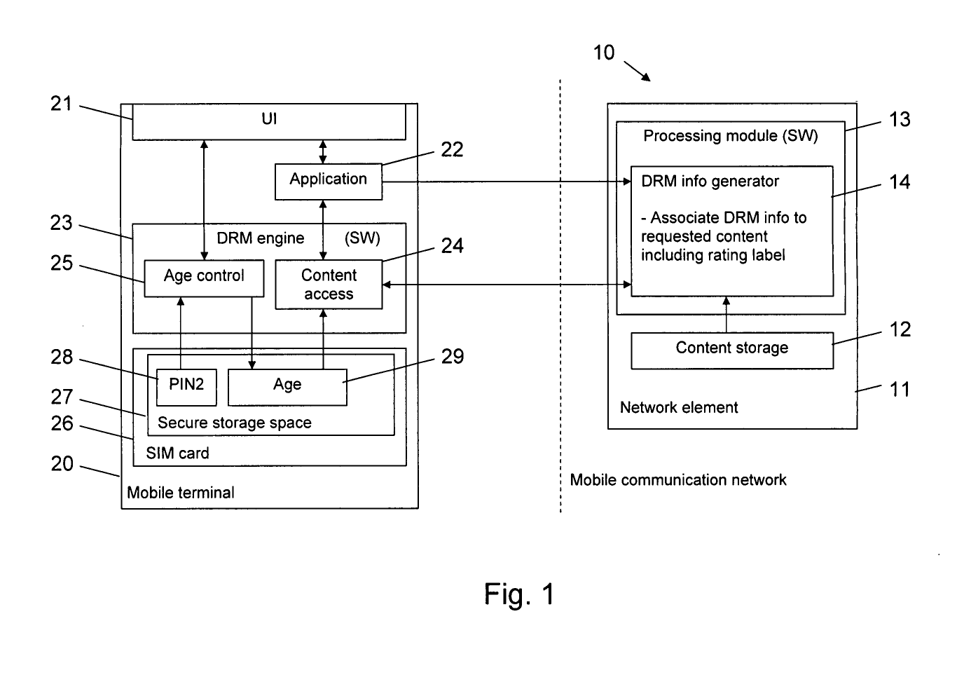

FIG. 1 is a schematic block diagram of an exemplary communication system according to an embodiment of the invention, which allows preventing certain users to use a certain type of content.

The system comprises by way of example a mobile communication network 10 including a network element 11, and a mobile terminal 20.

The network element 11 is a conventional server of a content provider, which has been supplemented in accordance with the invention. It comprises a content storage 12 and a processing module 13 including a DRM information generator 14. The functions of the processing module 13 can be realized for instance by software.

The mobile terminal 20 is a conventional mobile terminal 20 which has been supplemented in accordance with the invention. The mobile terminal 20 comprises a user interface 21, including for instance input means, a display and a loudspeaker. The mobile terminal 20 further comprises an application 22 which enables a user to download and consume certain content. The mobile terminal 20 further comprises a DRM engine 23. The DRM engine 23 forms a processing module according to an embodiment of the invention and controls the access to content by the application 22. Its functions can be realized for instance by software or by hardware such as an integrated circuit. If carried out by software, the engine is embodied in coded instructions stored in a memory device for execution by an instruction processing unit connected to said memory by a data, address and control bus to which are connected various related devices such as an input/output device, a random access memory, etc. The DRM engine 23 includes a content access portion 24 and an age control portion 25. The mobile terminal 20 further comprises as a second device an inserted SIM card 26 with a secure storage space 27, in which a PIN2 code 28 and an age indication 29 are stored. At least the PIN2 code 28 can only be read by the DRM engine 23. Moreover, only the DRM engine 23 is able to change the age indication 29. The assembly of mobile terminal 20 and SIM card 26 is an embodiment of a user system according to the invention.

The mobile terminal 20 is able to access the mobile communication network 10 and thus the network element 11 in a conventional manner.

The mobile terminal 20 may belong for example to an eleven year old child, and its parents may want to prevent their child from downloading and using content which is not appropriate for its age.

They set to this end the age indication in the secure storage space 27 of the SIM card 26 to the date of birth of the child. The access to the age indication 29 is enabled via the user interface 21 and the DRM engine 23 when entering a PIN2 code. The entered PIN2 code is compared by the age control portion 25 of the DRM engine 23 with the PIN2 code 28 stored in the secure storage space 27 of the SIM card 26. If the correct PIN2 code is entered, the DRM engine 23 allows changing the age indication 29 as desired. By default, the age indication 29 may be set for instance to a default value representing no access restriction.

In one embodiment of the invention, a user profile is defined to the mobile device, which user profile forces the DRM engine make the age verification. This profile may be arranged in a manner, that it work in co-operation of other user profiles, like “general”, “silent” etc. In this exemplary embodiment, exemplary user profiles may be, as by example, “general—age verification off” or “silent—age verification on”. Switching this profile on and off may require a password, which may be stored into tamperproof area of mobile device memory. Further, in one embodiment of the invention, the indication whether the above-mentioned profile is on or off, may be stored into tamperproof area of second memory device like SIM, memory card or any comparable device operatively connected into mobile device. Also the password required to turn the profile on and off may be stored into tamperproof memory area of the second device.

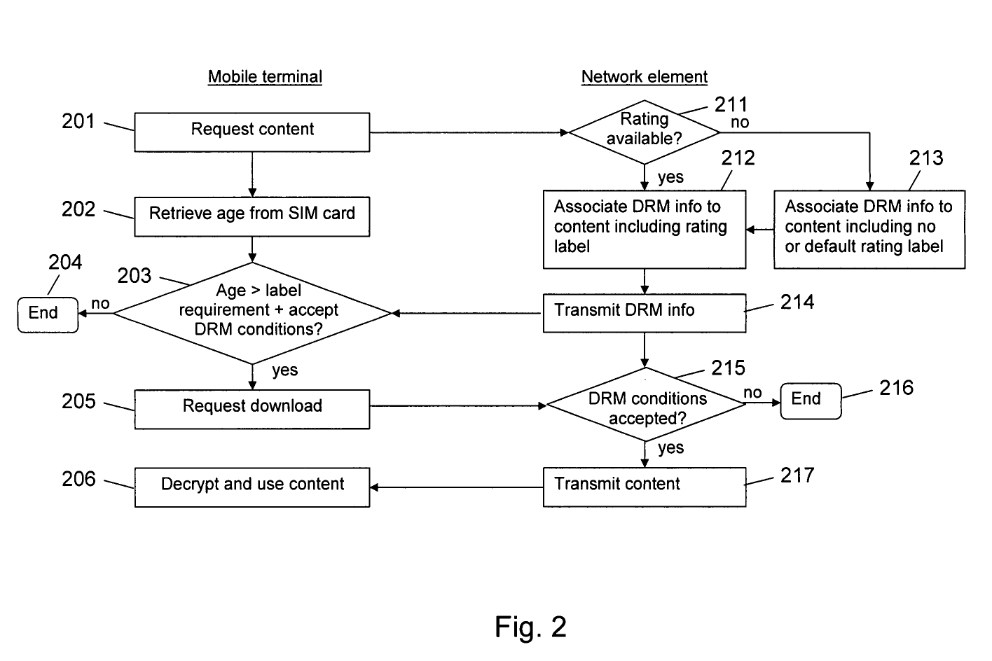

An operation in the system of FIG. 1, resulting when a user of the mobile terminal 20 request a download of content from the network element 11, will now be described with reference to FIG. 2. FIG. 2 is a flow chart which illustrates on the right hand side the operation at the network element 11 and on the left hand side the operation at the mobile terminal 20.

When the child using the mobile terminal 20 requests application 22 via the user interface 21 to download entertainment content from the network element 11, a content request is transmitted by the mobile terminal 10 to the network element 11 (step 201).

In parallel, the content access portion 24 of the DRM engine 23 retrieves the age indication 29 from the secure storage space 27 of the SIM card 26.

Upon receipt of a content request, the DRM information generator 14 of the network element 11 retrieves the requested content from the content storage 12 and determines whether a rating is available for this content (step 211). A rating indicates whether the content is suitable for persons above a certain age, for example for anyone, for persons older than six, twelve or sixteen years, or rather only for adults. The material may also be rated, but is not limited to, “contains physical violence”, “contains religiously offensive material”, “contains foul language”, as by example. There may also be more than one rating associated to a content. If a rating is available, the DRM information generator 13 generates conventional DRM information, but includes in addition a rating label corresponding to the available rating (step 212).

If no rating is available, the DRM information generator 13 generates conventional DRM information, and includes either no rating label or a default rating label indicating as well that the content might only be suited for adults (step 213).

The network element 11 then transmits the generated DRM information to the mobile terminal 20 (step 214).

The content access portion 24 of the DRM engine 23 of the mobile terminal 20 knows from the date of birth in the retrieved age indication 27 the current age of the assumed user, in the present example eleven years. The content access portion 24 now compares this age with the rating label included in the received DRM information. In addition, it checks whether the other DRM conditions included in the DRM information are to be accepted. The latter is carried out in a conventional manner and is not treated here in more detail. It may include for example a price which has to be accepted for downloading the requested content and a required decryption key. (step 203)

If the age of the user of the mobile terminal 10 is lower than the age for which the content is rated to be appropriate, access to the content is denied and a download is prevented. In the present example of a user of eleven years, an access is prevented in case the rating label indicates that the content is only appropriate for persons older than 12, 16 or 18 years, or in case no rating label is included in the DRM information. A download is prevented equally, if the DRM conditions are not to be accepted. (step 204)

If the age indication 27 shows that the user of the mobile terminal 10 is of an age exceeding the age for which the content is rated to be appropriate, and if in addition the DRM conditions are to be accepted, the DRM engine 23 requests the download of the requested content (step 205). In the present example of a user of eleven years, a download is allowed, in case the rating label indicates that the content is appropriate for anyone or for persons older than 6 years.

In one embodiment of the invention, there may be plurality of user-related indications stored in the second device. As an example of the use of this embodiment, one can consider a situation, in which parents wish not only to prevent their minors from consuming “adult”-labeled material, but also any content, which contains foul language. Other possible restrictions are, by example, consuming of a content, which some religious group may find offensive or a consuming a content, which contains any type of physical violence. In this exemplary embodiment, albeit the user of the device meets the age requirement for consuming the content, he or she may not meet the requirement that all physical violence is prohibited in the content he or she wishes to consume. In such a situation, consuming may be prevented.

The processing module 13 of the network element 11 monitors in the meantime whether it receives a message from the mobile terminal 10 indicating that the DRM conditions are accepted (step 215).

If the processing module 13 does not receive such a message, for instance within a predetermined period of time, the process is terminated (step 216).

If the processing module 13 receives such a message, in contrast, it transmits the requested content to the mobile terminal 20 (step 217).

When the mobile terminal 20 receives the requested content, the DRM engine 23 decrypts the content based on an available decryption key generated specifically for the mobile terminal 20, which is received together with the content or separately, and provides the decrypted content to the application 22 for presentation to the user via the user interface 21.

The presented embodiment of the invention thus allows filtering content which is to be downloaded in a reliable way depending on the age of the regular user of the mobile terminal. If a minor wants to download some appropriate fun, this is still possible. If the user is a child and the parents keep the PIN2 code at a safe place, the child is not able to modify the stored date of birth information. The filtering is also reliable, as DRM information, which does not contain any rating label is automatically considered not to be appropriate-for minors. It also increases the business opportunities for Operators and content providers for selling content, as there is no need anymore to prevent a download of content completely.

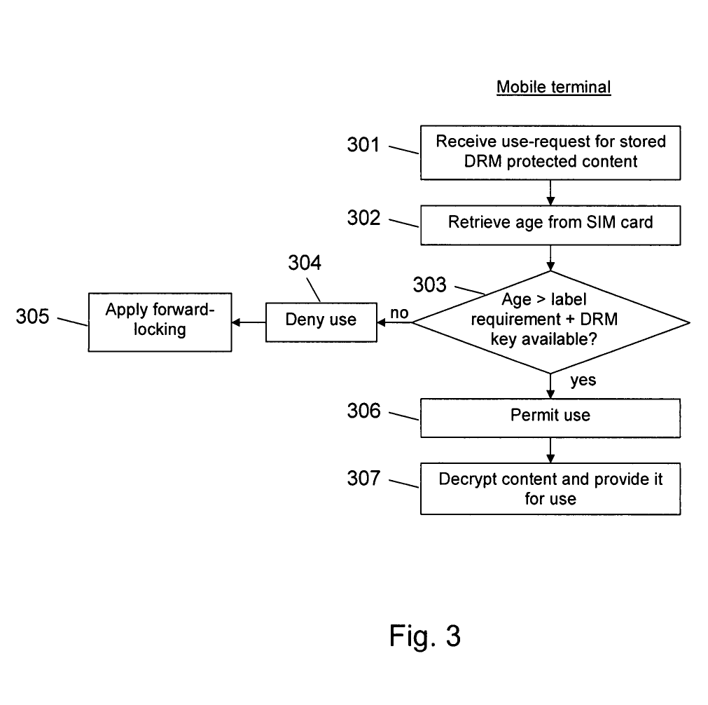

An operation in the system of FIG. 1, resulting when a user of the mobile terminal 20 requests a use of stored DRM protected content, will now be described with reference to FIG. 3. FIG. 3 is a flow chart which illustrates a second type of operation at the mobile terminal 20.

The mobile terminal 20 is assumed to comprise a memory (not shown) in which DRM protected content may be stored. Such DRM protected content may be pushed or pulled into the mobile terminal 20 from a PC, for example through a wired connection or a wireless near-field connection. DRM information associated to the stored DRM protected content may comprise a rating label. A rating indicates whether the content is suitable for persons above a certain age, for example for anyone, for persons older than six, twelve or sixteen years, or rather only for adults.

When a child using the mobile terminal 20 requests application 22 via the user interface 21 to use stored entertainment content (step 301), the content access portion 24 of the DRM engine 23 retrieves the age indication 29 from the secure storage space 27 of the SIM card 26 (step 302).

The content access portion 24 of the DRM engine 23 of the mobile terminal 20 knows from the date of birth in the retrieved age indication 27 the current age of the assumed user, in the present example eleven years. The content access portion 24 now compares this age with the rating label included in the DRM information associated to the requested content. In addition, it checks whether the DRM information comprises a valid DRM decryption key for the requested DRM protected content. (step 303)

If the age of the user of the mobile terminal 10 is lower than the age for which the content is rated to be appropriate, access to the content is denied. In the present example of a user of eleven years, an access is prevented in case the rating label indicates that the content is only appropriate for persons older than 12, 16 or 18 years, or in case no rating label is included in the DRM information. A consumption of the content is equally prevented, if no suitable DRM decryption key is available. (step 304)

In addition to simply preventing the use of the content, the content may be modified, for instance by making it impossible to copy it to another device by a forward-locking (step 305). The minor who has copied some content to his mobile terminal 20 which has been rated to be suited only for adults may have a minor friend. The parents of this minor friend may not have the same type of content use control in their personal computer as the content use control, which is implemented in the mobile terminal 20. They only have some software installed, which prevents access to certain Internet pages and/or prevents downloading of material, which is rated to be suitable only for adults. Copying the content from the mobile terminal 20 to the personal computer would thus enable the minor to make use of the content in spite of the rating. By modifying the content, it can also be prevented that the mobile terminal 20 is used as a “physical container”, which is used to carry inappropriate content around for transferring it to another device which permits the use of any content.

If the age indication 29 shows that the user of the mobile terminal 20 is of an age exceeding the age for which the content is rated to be appropriate, and if in addition the required DRM decryption key is available, the DRM engine 23 permits the use of the requested content (step 306). In the present example of a user of eleven years, a content consumption is allowed, in case the rating label indicates that the content is appropriate for anyone or for persons older than 6 years.

The DRM engine 23 thus decrypts the content based on the available decryption key generated specifically for the mobile terminal 20, and provides the decrypted content to the application 22 for presentation to the user via application 22 and user interface 21. (step 307)

The presented embodiment of the invention thus allows filtering content which is already available in the mobile terminal in a reliable way depending on the age of the regular user of the mobile terminal. If a minor wants to consume some appropriate fun, this is still possible. If associated DRM information does not contain any rating label, the content is automatically considered not to be appropriate for minors.

It is to be noted that the described embodiment constitutes only one of a variety of possible embodiments of the invention.

1. Processing module (23) for a user device (20),
which processing module (23) is adapted to compare at least one attribute associated to a user of said user device (20), an indication (29) of which at least one attribute is stored in a second device (26) and is accessible by said user device (20), with information on a rating of content, when content is requested to be accessed and when information on a rating of said content is available in said user device (20); and
which processing module (23) is adapted to determine based on said comparison whether said content is allowed to be to be accessed by said user.

2. Processing module (23) according to claim 1, wherein said information on a rating is included in digital rights management related information provided to said user device (20).

3. Processing module (23) according to claim 1, wherein information on a rating is provided to said user device (20) via a communication network (10).

4. Processing module (23) according to claim 1, wherein said information on a rating is provided by a secure server to said user device (20).

5. Processing module (23) according to claim 1, wherein said rating is related to an age of users which are to be allowed to access said content.

6. Processing module (23) according to claim 1, wherein said attribute associated to a user of said mobile device (20) is related to an age of said user.

7. Processing module (23) according to claim 1, wherein said rating is related to a corporate user identification of users, which are to be allowed to access said content.

8. Processing module (23) according to claim 1, wherein said attribute associated to a user of said mobile device (20) is related to a corporate user identification of said user.

9. Processing module (23) according to claim 1, wherein said indication of said attribute is non-changeable.

10. Processing module (23) according to claim 1, wherein said processing module (23,25) is adapted to enable a user to change said indication of said attribute after having entered a predetermined code (28).

11. Processing module (23) according to claim 1, wherein said processing module (23) is adapted to modify content which has been determined not to be allowed to be accessed by said user by at least one of:
marking said content with a hide attribute, which causes hiding said content from a user of said user device (20);
making said content unusable; and
making said content impossible to forward or copy.

12. User device (20) comprising a processing module (23) according to claim 1.

13. User device (20) according to claim 12, wherein said user device (20) is a mobile terminal and wherein said second device (26) storing said indication of said attribute is a subscriber identity module (26).

14. User device (20) according to claim 12, wherein a user profile defined in said user device (20) is updated for any content access request in accordance with said stored indication.

15. User system for controlling access to a content, said user system comprising a user device (20) according to claim 12 and a second device (26) storing said indication of said attribute.

16. Method for controlling in a user device (20) an access to content, said method comprising:
comparing at least one attribute associated to a user of said user device (20), an indication (29) of which at least one attribute is stored in a second device (26) and is accessible by said user device (20), with information on a rating of content, when content is requested to be accessed, and when information on a rating of said content is available in said user device (20); and
determining based on said comparison whether said content is allowed to be accessed by said user.

17. A software code for controlling in a user device (20) an access to at least one of a use of content, wherein, said software code realizing the following steps when running in a processing module of a user device (20):
comparing at least one attribute associated to a user of said user device (20), an indication (29) of which at least one attribute is stored in a second device (26) and is accessible by said user device (20), with information on a rating of content, when content is requested to be accessed and when information on a rating of said content is available in said user device (20); and
determining based on said comparison whether said content is allowed to be accessed by said user.

18. A software program product in which a software code according to claim 17 is stored.

19. Processing module (13) for a network element (11) of a communication network (10), which communication network (10) enables a user device (20) to download content, wherein said processing module (13) is adapted to provide for content requested by a user device (10) for download information on a content dependent rating, which rating indicates whether users are to be allowed by a user device (20) to access said content, depending on at least one attribute associated to a user, an indication of which at least one attribute is stored in a second device (26) accessible by a respective user device (20).

20. Processing module (13) according to claim 19, wherein said processing module (23) is adapted to include said rating in digital rights management related information which is provided to said user device (20).

21. Processing module (13) according to claim 19, wherein said rating is related at least to an age of users which are to be allowed by a user device (20) to access use or to download said content.

22. Network element (11) for a communication network (10) comprising a processing module (13) according to claim 19.

23. Method for supporting in a network element (11) of a communication network (10) a control by a user device (20) of an access to at least one of a use of content and a download of content, said method comprising providing for content requested by a user device (10) for download information on a content dependent rating, which rating indicates whether a user is to be allowed by said user device (20) to access said content, depending on at least one attribute associated to a user, an indication of which at least one attribute is stored in a second device (26) accessible by a respective user device (20).

24. A software code for supporting in a network element (11) of a communication network (10) a control by a user device (20) of an access to content, said software code realizing the following step when running in a processing module of a network element (11): providing for content requested by a user device (10) for download information on a content dependent rating, which rating indicates whether a user is to be allowed by a user device (20) to access said content, depending on at least one attribute associated to a user, an indication of which at least one attribute is stored in a second device (26) accessible by a respective user device (20).

25. A software program product in which a software code according to claim 24 is stored.

26. Communication system comprising at least one user device (20) including a processing module (23) according to claim 1 and at least one network element (11) for a communication network (10) that enables said user device to download content, said processing module (13) adapted to provide for content requested by said at least one user device for download information on a content dependent rating, which rating indicates whether users are to be allowed by said at least one user device to access said content, depending on at least one attribute associated to a user, an indication of which at least one attribute is stored in a second device (26) accessible by said at least one user device.
